(19) United States
(12) Patent Application Publication
(10) Pub. No.: US 2007/0196688 A1
(43) Pub. Date: Aug. 23, 2007

(54) ORGANIC ELECTROLUMINESCENCE DEVICE

(75) Inventors: Kiyoshi Ikeda, Sodegaura-shi (JP); Mitsunori Ito, Sodegaura-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/563,102

(22) Filed: Nov. 24, 2006

(30) Foreign Application Priority Data
Feb. 23, 2006 (JP) 2006-046743

(51) Int. Cl. B32B 9/00; B32B 19/00

(52) U.S. Cl. 428/690; 428/917

(57) ABSTRACT

An organic electroluminescent device including: a cathode, an anode, and an organic thin film layer provided between the cathode and the anode, the organic thin layer including one or plural layers including an emitting layer; at least one layer of the organic thin film layer including an indenoperylene compound having at least one substituent on the central perylene ring, and a compound having a condensed aromatic ring with 10 to 50 nucleus carbon atoms.

### TECHNICAL FIELD

The invention relates to an organic electroluminescent device (hereinafter referred to as organic EL device)

### BACKGROUND

An organic EL device is a self-emission device by the use of the principle that a fluorescent compound emits light by the recombination energy of holes injected from an anode and electrons injected from a cathode when an electric field is impressed.

Since C. W. Tang et al. of Eastman Kodak Co. reported a low-voltage driven organic EL device in the form of a stacked type device (Non-patent Document 1), studies on organic EL devices wherein organic materials are used as the constituent materials has actively conducted.

Tang et al. uses tris(8-quinolinol) aluminum for an emitting layer and a triphenyldiamine derivative for a hole-transporting layer in the stacked structure. The advantages of the stacked structure are to increase injection efficiency of holes to the emitting layer, to increase generation efficiency of excitons generated by recombination by blocking electrons injected in the cathode, to confine the excitons generated in the emitting layer, and so on. Like this example, as the structure of the organic EL device, a two-layered type of a hole-transporting (injecting) layer and an electron-transporting emitting layer, and a three-layered type of a hole-transporting (injecting) layer, an emitting layer and an electron-transporting (injecting) layer are widely known. In such stacked structure devices, the device structures and the fabrication methods have been contrived to increase recombination efficiency of injected holes and electrons.

Patent document 1 discloses a device wherein a dicyanoanthracene derivative and an indenoperylene derivative are used in an emitting layer, and a metal complex is used in an electron-transporting layer. However, the emission color thereof is not pure red, and is reddish orange because the CIE chromaticity is (0.63, 0.37). Holes are injected through the emitting layer into the electron-transporting layer to recombine with electrons in the electron-transporting layer. The metal complex of the electron-transporting layer then emits slightly to degrade the chromaticity. Further, the electron-transporting layer having a low hole resistance deteriorates so that the lifetime is remarkably shorten.

Patent document 2 discloses a red device wherein a naphthacene derivative and an indenoperylene derivative are used in an emitting layer, and a naphthacene derivative is used in an electron-transporting layer. The device has a high color purity and a practical lifetime. However, the device requires two organic layers (electron-transporting layer and electron-injecting layer) which have separated functions and are arranged between an anode and a cathode to improve color purity and lifetime. The structure of the device is complicated.

Patent document 3 proposes an emission-preventing layer which has a greater band gap than those of an emitting layer and an electron-transporting layer for suppressing emission of the electron-transporting layer. However, the luminous efficiency of the emitting device is as insufficient as about 1 cd/A.
[Patent document 1] JP-A-2001-307885
[Patent document 2] JP-A-2003-338377
[Patent document 3] JP-A-2005-235564
[Non-patent document 1] C. W. Tang, S. A. Vanslyke, Applied Physics Letters, 51, 913, 1987

In view of the above problems, an object of the invention is to provide an organic EL device having excellent color purity, and practical luminous efficiency and lifetime.

### DISCLOSURE OF THE INVENTION

The inventors of the invention have conducted extensive studies in order to achieve the above object. As a result, the inventors have found that luminous efficiency and lifetime are improved by forming an organic thin film layer by combining an indenoperylene compound having one or more substituents on the central perylene ring and a compound having a specific condensed aromatic ring. This finding has led to the completion of the invention.

The invention provides the following organic EL device.

1. An organic electroluminescent device comprising:

a cathode,

an anode, and

an organic thin film layer provided between the cathode and the anode, the organic thin layer comprising one or plural layers including an emitting layer;

at least one layer of the organic thin film layer comprising an indenoperylene compound having at least one substituent on the central perylene ring, and a compound having a condensed aromatic ring with 10 to 50 nucleus carbon atoms.

2. The organic electroluminescent device according to 1 wherein the indenoperylene compound is a compound represented by the following formula (1) or (2): 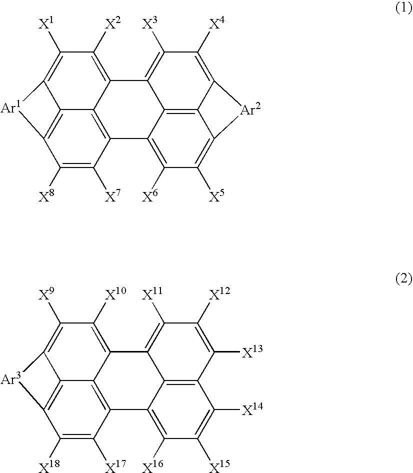
wherein Ar¹, Ar² and Ar³ are each independently a substituted or unsubstituted aromatic ring group, or aromatic heterocyclic group; X¹ to X¹⁸ are each independently a hydrogen atom, halogen atom, alkyl group, alkoxy group, alkylthio group, alkenyl group, alkenyloxy group, alkenylthio group, aromatic-ring-containing alkyl group, aromatic-ring-containing alkyloxy group, aromatic-ring-containing alkylthio group, aromatic ring group, aromatic heterocyclic group, aromatic ring oxy group, aromatic ring thio group, aromatic ring alkenyl group, alkenyl aromatic ring group, amino group, carbazolyl group, cyano group, hydroxyl group, —COOR^{1′} (R^{1′} is a hydrogen atom, alkyl group, alkenyl group, aromatic-ring-containing alkyl group, or aromatic ring group), —COR^{2′} (R^{2′} is a hydrogen atom, alkyl group, alkenyl group, aromatic-ring-containing alkyl group, aromatic ring group or amino group) or —OCOR^{3′} (R^{3′} is an alkyl group, alkenyl group, aromatic-ring-containing alkyl group or aromatic ring group); adjacent groups of X¹ to X¹⁸ may be bonded to each other to form a ring with a substituted carbon atom; and at least one of X¹ to X¹⁸ is not a hydrogen atom.

3. The organic electroluminescent device according to 1 or 2 wherein the indenoperylene compound is a dibenzo tetraphenyl perifuranthene derivative.

4. The organic electroluminescent device according to any one of 1 to 3 wherein the compound having a condensed aromatic ring with 10 to 50 nucleus carbon atoms is an anthracene derivative of the following formula (3), unsymmetrical anthracene derivative of the following formula (4), unsymmetrical pyrene derivative of the following formula (5) unsymmetrical diphenylanthracene derivative of the following formula (6), or bispyrene derivative of the following formula (7): 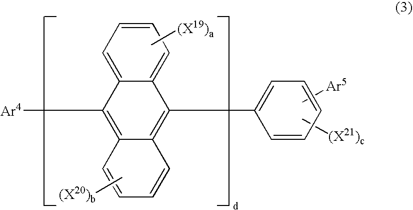
wherein X¹⁹ to X²¹ are each a hydrogen atom, substituted or unsubstituted aromatic group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arythio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; Ar⁴ and Ar⁵ are each independently a substituted or unsubstituted condensed aromatic group having 10 to 50 nucleus carbon atoms ; and at least one of Ar⁴ and Ar⁵ is a 1-naphthyl group represented by the following formula (3a) or 2-naphthyl group represented by the following formula (3b), 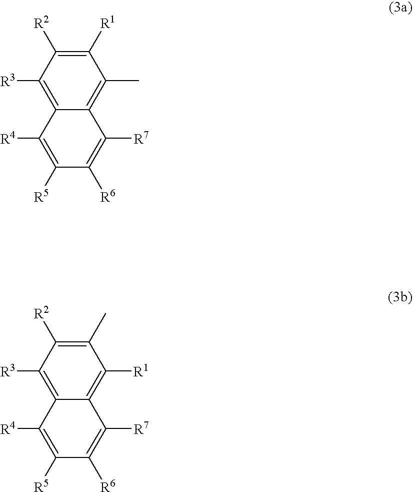
(wherein R¹ to R⁷ are each independently a hydrogen atom, or substituted or unsubstituted alkyl group having 1 to 50 carbon atoms; and at least one pair of adjacent groups of R¹ to R⁷ is bonded to each other to form a cyclic structure); a, b and c are each an integer of 0 to 4; d is an integer of 1 to 3; and the groups in [ ] of the formula may be the same or different when d is 2 or more: 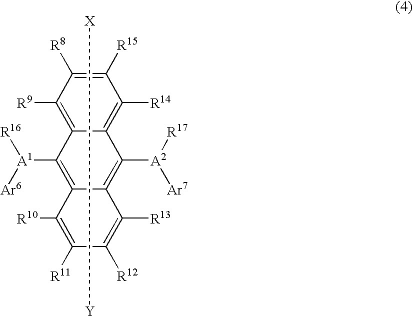
wherein A¹ and A² are independently a substituted or unsubstituted condensed aromatic hydrocarbon ring group having 10 to 20 nucleus carbon atoms; Ar⁶ and Ar⁷ are independently a hydrogen atom or substituted or unsubstituted aromatic hydrocarbon ring group with 6 to 50 nucleus carbon atoms; R⁸ to R¹⁵ are independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, a substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; R¹⁶ and R¹⁷ are each independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; and a plurality of Ar⁶, Ar⁷, R¹⁶ and R¹⁷ may bond to A¹ or A², or adjacent groups thereof may form a saturated or unsaturated cyclic structure; provided that groups do not symmetrically bond to 9 and 10 positions of the central anthracene with respect to X-Y axis: 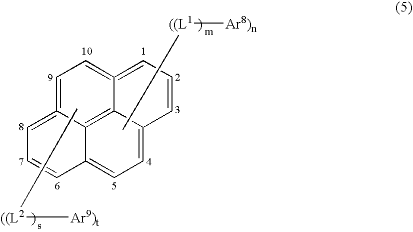
wherein Ar⁸ and Ar⁹ are each a substituted or unsubstituted aromatic group having 6 to 50 nucleus carbon atoms; L¹ and L² are each a substituted or unsubstituted phenylene group, substituted or unsubstituted naphthalenylene group, substituted or unsubstituted fluolenylene group, or substituted or unsubstituted dibenzosilolylene group; m is an integer of 0 to 2, n is an integer of 1 to 4, s is an integer of 0 to 2, and t is an integer of 0 to 4; L¹ or Ar⁸ bonds at any one position of 1 to 5 of the pyrene, and L² or Ar⁹ bonds at any one position of 6 to 10 of the pyrene; provided that when n+t is an even number, Ar⁸, Ar⁹, L¹ and L² satisfy the following (1) or (2):

(1) Ar⁸≠Ar⁹ and/or L¹≠L² where ≠ means that they are groups having different structures from each other.

(2) when Ar⁸═Ar⁹ and L¹=L²,

(2-1) m≠s and/or n≠t, or

(2-2) when m=s and n=t,
(2-2-1) L¹ and L², or the pyrene each bond to Ar⁸ and Ar⁹ at different positions, or
(2-2-2) when L¹ and L², or the pyrene each bond to Ar⁸ and Ar⁹ at the same positions, L¹ and L², or Ar⁸ and Ar⁹ are not in symmetric relation at substitution position in the pyrene: 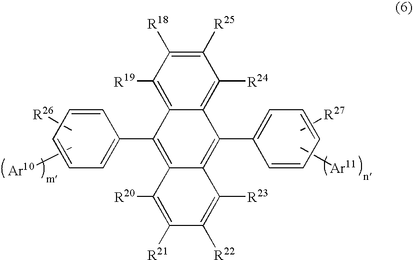
   wherein Ar¹⁰ and Ar¹¹ are each independently a substituted or unsubstituted aromatic hydrocarbon ring group having 6 to 50 nucleus carbon atoms; and m′ and n′ are each an integer of 1 to 4; provided that in the case where m′=n′=1, and Ar¹⁰ and Ar¹¹ are symmetrically bonded to the benzene rings, Ar¹⁰ and Ar¹¹ are not the same, and in the case where m′ or n′ is an integer of 2 to 4, m′ is different from n′;

R¹⁸ to R²⁵ are each independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; and

R²⁶ and R²⁷ are each independently a hydrogen atom, substituted or unsubstituted aromatic hydrocarbon ring group having 6 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group:
(A³)ₑ-(X²²)_{f}—(Ar¹²)_{g}—(Y¹)ₕ—(B¹)ᵢ (7)
wherein X²² is independently a substituted or unsubstituted pyrene residue, A³ and B¹ are a hydrogen atom, a substituted or unsubstituted aromatic hydrocarbon group having 3 to 50 nucleus carbon atoms, a substituted or unsubstituted aromatic heterocyclic group having 1 to 50 nucleus carbon atoms, a substituted or unsubstituted alkyl group or alkylene group having 1 to 50 carbon atoms, or a substituted or unsubstituted alkenyl group or alkenylene group having 1 to 50 carbon atoms, Ar¹² is independently a substituted or unsubstituted aromatic hydrocarbon group having 3 to 50 nucleus carbon atoms or a substituted or unsubstituted aromatic heterocyclic group having 1 to 50 nucleus carbon atoms, and Y¹ is independently a substituted or unsubstituted aryl group. f is an integer of 1 to 3, e and i are independently integers of 0 to 4, h is an integer of 0 to 3, and g is an integer of 1 to 5.

5. The organic electroluminescent device according to any one of 1 to 3 wherein the compound having a condensed aromatic ring with 10 to 50 nucleus carbon atoms is a compound represented by the following formula (8):
X²³—(Y²)ⱼ (8)
wherein X²³ is a condensed aromatic ring group having two or more carbon rings, and Y² is independently a substituted or unsubstituted aryl group, a substituted or unsubstituted diarylamino group, a substituted or unsubstituted arylalkyl group, or a substituted or unsubstituted alkyl group. j is an integer of 1 to 6. When j is 2 or more, the Y²s may be the same or different.

6. The organic electroluminescent device according to 5 wherein X²³ of the formula (8) is derived from a compound containing a skeleton having 4 or more carbocycles selected from the group consisting of naphthacene, pyrene, benzoanthracene, pentacene, dibenzoanthracene, benzopyrene, benzofluorene, fluoranthene, benzofluoranthene, naphthylfluoranthene, dibenzofluorene, dibenzopyrene, dibenzofluoranthene and acenaphtylfluoranthene.

7. The organic electroluminescent device according to 5 wherein the compound represented by the formula (8) is one or more compounds selected from the group consisting of naphthacene derivatives, anthracene derivatives, benzoanthracene derivatives, dibenzoanthracene derivatives, pentacene derivatives, bisanthracene derivatives, pyrene derivatives, bispyrene derivatives, benzopyrene derivatives, dibenzopyrene derivatives, fluorene derivatives, benzofluorene derivatives, dibenzofluorene derivatives, fluoranthene derivatives, benzofluoranthene derivatives, dibenzofluoranthene derivatives, naphthylfluoranthene derivatives, acenaphthylfluoranthene derivatives, diaminoanthracene derivatives, naphthofluoranthene derivatives, diaminopyrene derivatives, diaminoperylene derivatives, dibenzidine derivatives, aminoanthracene derivatives, aminopyrene derivatives and dibenzochrysene derivatives.

8. The organic electroluminescent device according to any one of 1 to 7 wherein the emitting layer comprises the indenoperylene compound and the compound having a condensed aromatic ring with 10 to 50 nucleus carbon atoms.

9. The organic electroluminescent device according to any one of 1 to 8 wherein the organic thin film layer comprises an electron transporting layer, and the electron transporting layer comprises an aromatic hydrocarbon compound represented by the following formula (9)
A⁴-B² (9)
wherein A⁴ is an aromatic hydrocarbon group having two or more carbocycles, and B² is a substituted or unsubstituted heterocyclic group.

10. The organic electroluminescent device according to 9 wherein A⁴ of the formula (9) is a heterocyclic compound containing in the molecule thereof at least one skeleton selected from anthracene, phenanthrene, naphthacene, pyrene, chrysene, benzoanthracene, pentacene, dibenzoanthracene, benzopyrene, fluorene, benzofluorene, fluoranthene, benzofluoranthene, naphthofluoranthene, dibenzofluorene, dibenzopyrene and dibenzofluoranthene.

11. The organic electroluminescent device according to 9 or 10 wherein the compound represented by the formula (9) is a nitrogen-containing heterocyclic compound.

12. The organic electroluminescent device according to 11 wherein the nitrogen-containing heterocyclic compound is a compound represented by the following formula (10) or (11): 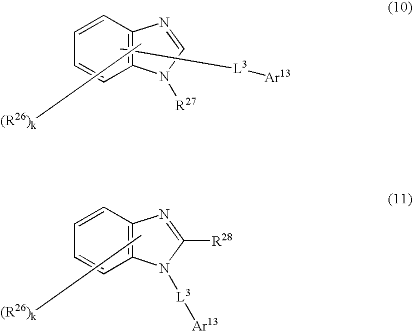
wherein R²⁶s are each independently a hydrogen atom, substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or substituted or unsubstituted alkoxy group having 1 to 20 carbon atoms; k is an integer of 0 to 4; R²⁷ is a substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or alkoxy group having 1 to 20 carbon atoms; R²⁸ is a hydrogen atom, substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or substituted or unsubstituted alkoxy group having 1 to 20 carbon atoms; L³ is a substituted or unsubstituted arylene group having 6 to 60 carbon atoms, substituted or unsubstituted pyridinylene group, substituted or unsubstituted quinolinylene group, or substituted or unsubstituted fluorenylene group; Ar¹³ is a substituted or unsubstituted arylene group having 6 to 60 carbon atoms, substituted or unsubstituted pyridinylene group, or substituted or unsubstituted quinolinylene group.

13. The organic electroluminescent device according to 11 wherein the nitrogen-containing heterocyclic compound is a compound containing at least one skeleton selected from pyridine, pyrimidine, pyrazine, pyridazine, triazine, quinoline, quinoxaline, acridine, imidazopyridine, imidazopyrimidine and phenenthroline.

14. The organic electroluminescent device according to any one of 1 to 13 whose emission color is orange to red.

15. The organic electroluminescent device according to any one of 1 to 14 wherein the emitting layer contains a dopant material, and the concentration of the dopant material contained in the emitting layer is 0.1 to 10 wt %.

16. The organic electroluminescent device according to 15 wherein the concentration of the dopant material is 0.5 to 2 wt %.

The invention provides an organic EL device excellent in color purity and luminous efficiency with a long lifetime.

### BRIEF DESCRIPTION OF THE DRAWINGS

FIG. 1 is a diagram showing one embodiment of an organic EL device of the invention.

### BEST MODE FOR CARRYING OUT THE INVENTION

An organic EL device according to the invention is described below in detail.

The organic EL device according to the invention includes a cathode, an anode, and an organic thin film layer provided between these electrodes and formed of one or more layers including an emitting layer.

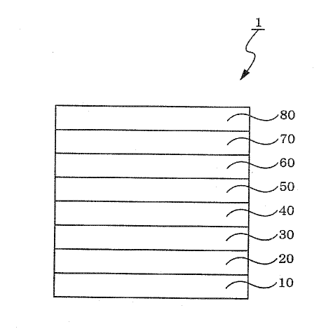

FIG. 1 is a cross-sectional view showing an example of the organic EL device according to the invention.

An organic EL device 1 has a configuration in which an anode 20, a hole injecting layer 30, a hole transporting layer 40, an emitting layer 50, an electron transporting layer 60, an electron injecting layer 70, and a cathode 80 are stacked on a substrate 10 in that order. In this device, the organic thin film layer is formed of the hole injecting layer 30, the hole transporting layer 40, the emitting layer 50, the electron transporting layer 60, and the electron injecting layer 70.

In the invention, at least one layer forming the organic thin film layer contains an indenoperylene compound having at least one substituent on the central perylene ring (compound A), and a compound having a condensed aromatic ring having 10 to 50 nucleus carbon atoms (compound B). A highly efficient red organic EL device exhibiting excellent color purity is obtained by using these compounds in combination.

As examples of the compound A, compounds of the following formula (1) or (2) can be given. 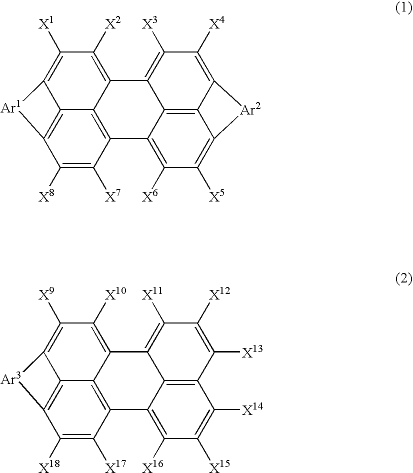
wherein Ar¹, Ar² and Ar³ are each independently a substituted or unsubstituted aromatic ring group, or aromatic heterocyclic group; X¹ to X¹⁸ are each independently a hydrogen atom, halogen atom, alkyl group, alkoxy group, alkylthio group, alkenyl group, alkenyloxy group, alkenylthio group, aromatic-ring-containing alkyl group, aromatic-ring-containing alkyloxy group, aromatic-ring-containing alkylthio group, aromatic ring group, aromatic heterocyclic group, aromatic ring oxy group, aromatic ring thio group, aromatic ring alkenyl group, alkenyl aromatic ring group, amino group, carbazolyl group, cyano group, hydroxyl group, —COOR^{1′} (R^{1′} is a hydrogen atom, alkyl group, alkenyl group, aromatic-ring-containing alkyl group, or aromatic ring group), —COR^{2′} (R^{2′} is a hydrogen atom, alkyl group, alkenyl group, aromatic-ring-containing alkyl group, aromatic ring group or amino group) or —OCOR^{3′} (R^{3′} is an alkyl group, alkenyl group, aromatic-ring-containing alkyl group or aromatic ring group); adjacent groups of X¹ to X¹⁸ may be bonded to each other to form a ring with a substituted carbon atom; and at least one of X¹ to X¹⁸ is not a hydrogen atom.

As preferred examples of Ar¹ to Ar³, a substituted or unsubstituted phenyl group and naphthyl group can be given.

As preferred examples of X¹ to X¹⁸, a substituted or unsubstituted phenyl group, biphenyl group, terphenyl group, methyl group, ethyl group, propyl group, butyl group, and cyclohexyl group can be given.

Compounds having the following structure may also be used in addition to the compounds of the formula (1) or (2). 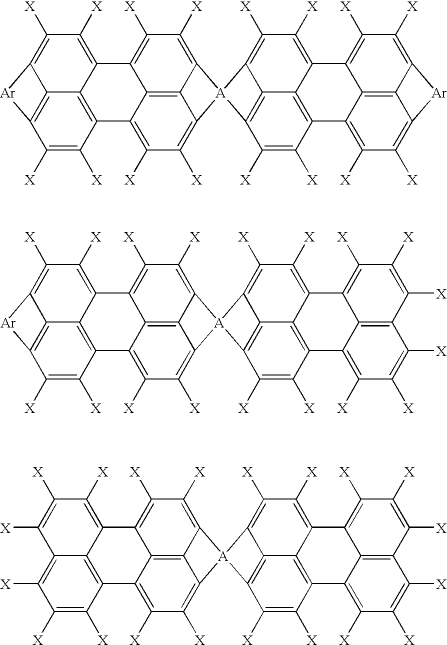
wherein Ar and X are substituents similar to Ar¹, X¹, or the like in the formula (1) or (2). A is a substituted or unsubstituted phenyl group or naphthyl group.

As the compound A, a dibenzotetraphenylperifuranthene derivative is particularly preferable.

The number of nucleus carbon atoms of the basic skeleton of the compound A is preferably 45 to 100. If the number of nucleus carbon atoms is less than 45, heat resistance may deteriorate. If the number of nucleus carbon atoms exceeds 100, a film may not be formed by deposition or the like due to an insufficient vapor pressure when fabricating the device, or it may be difficult to form a film by coating due to difficulty in preparing a solution.

Specific examples of the compound A are given below. These compounds may be synthesized referring to JP-A-10-330295 or the like.

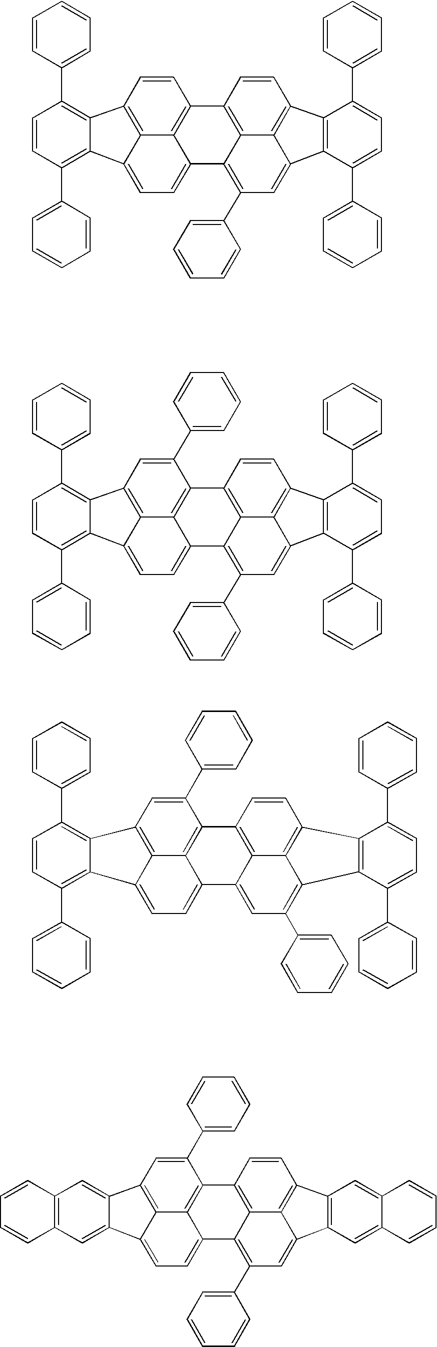

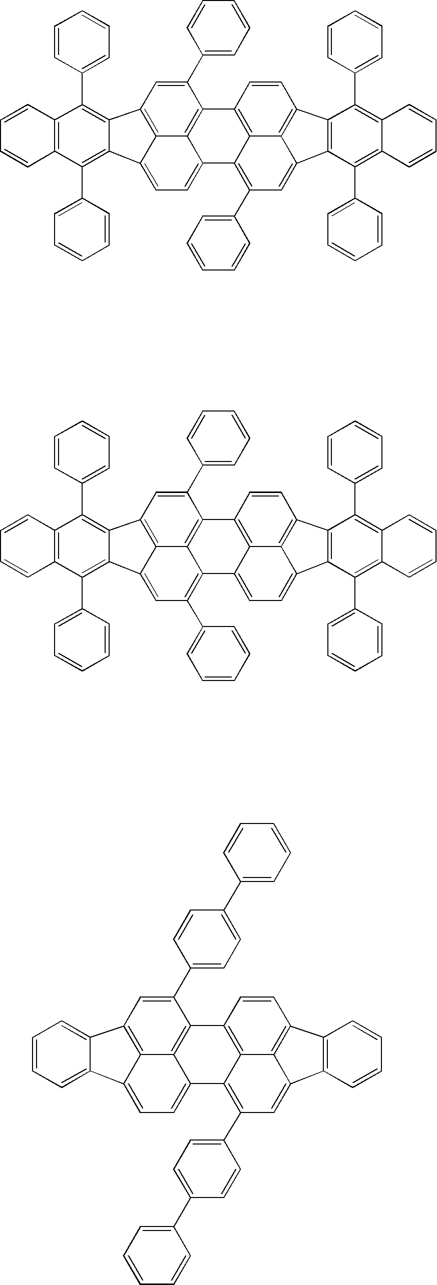

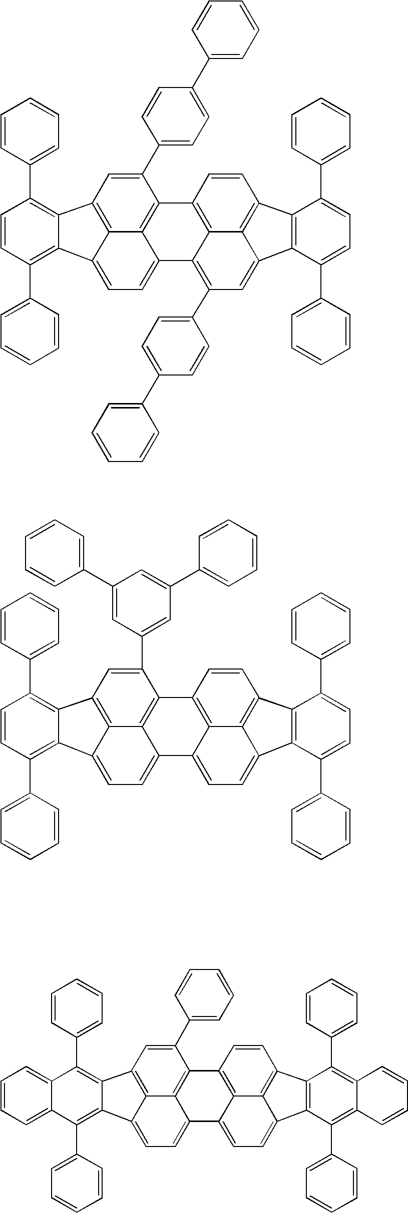

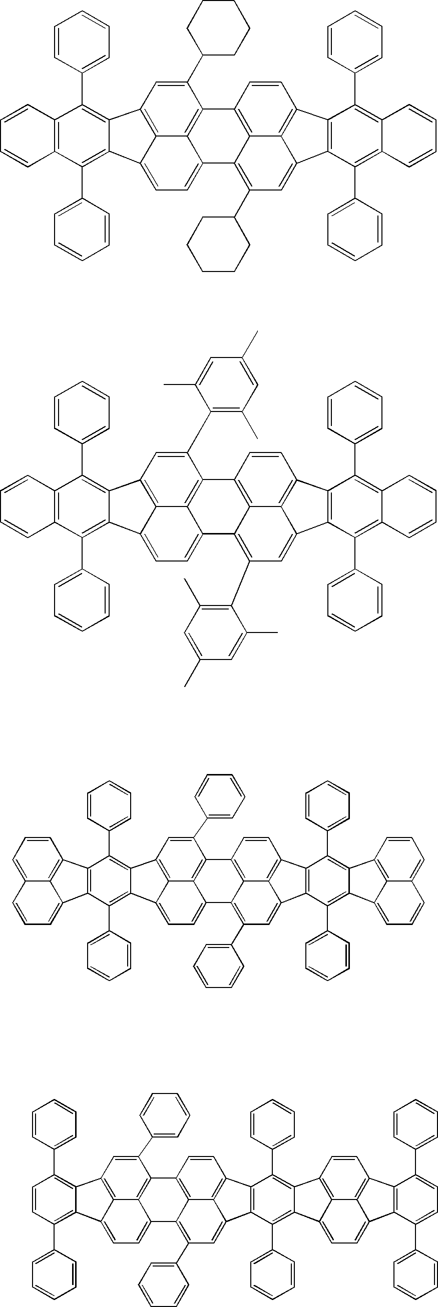

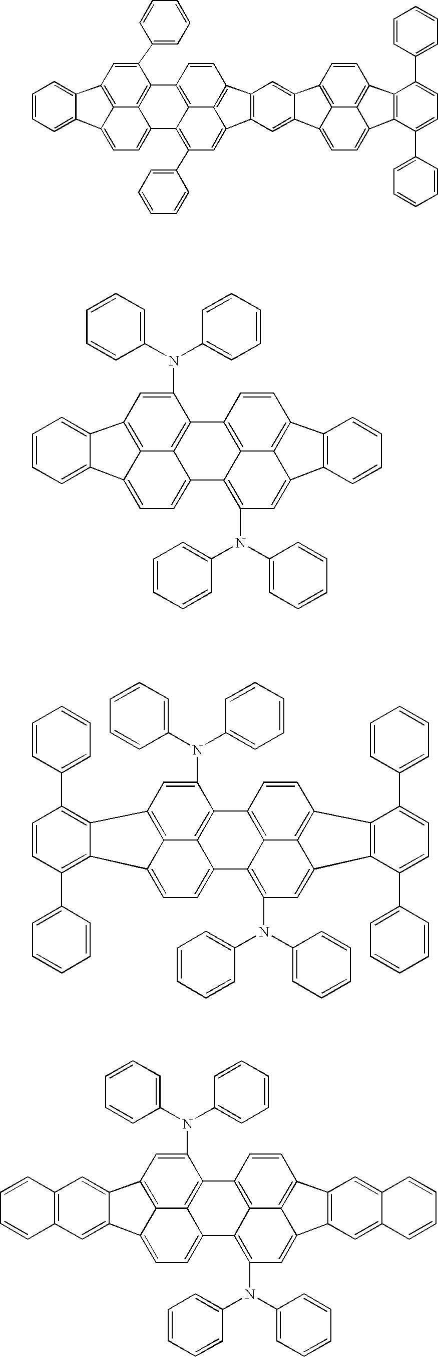

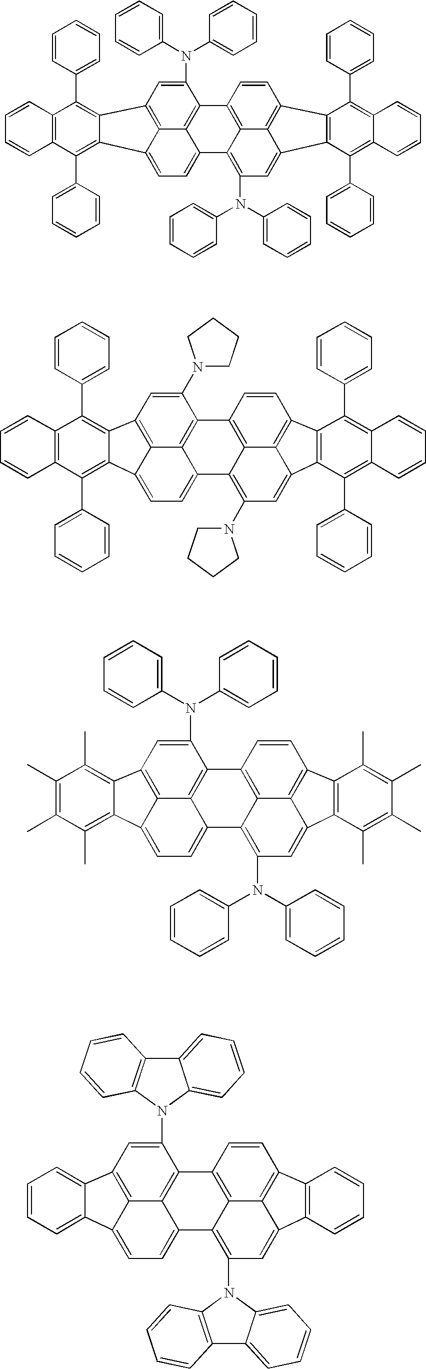

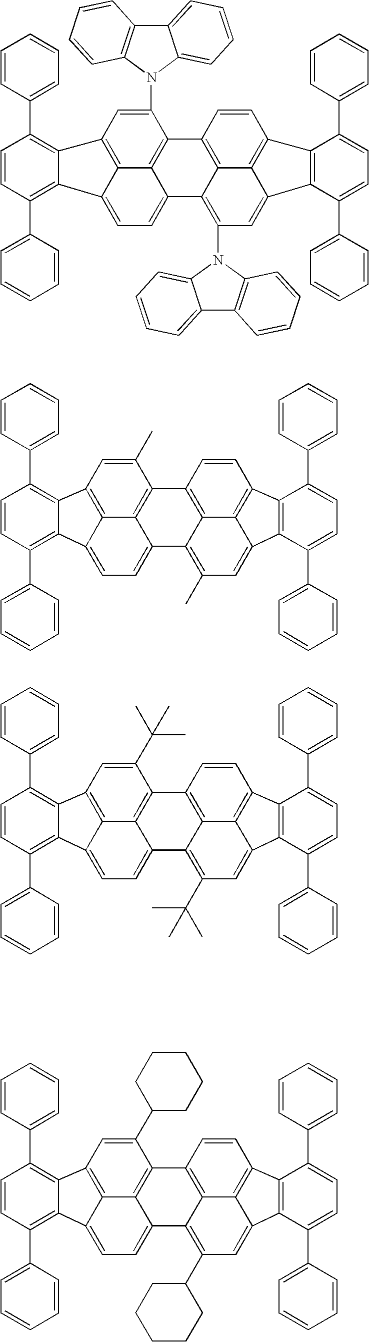

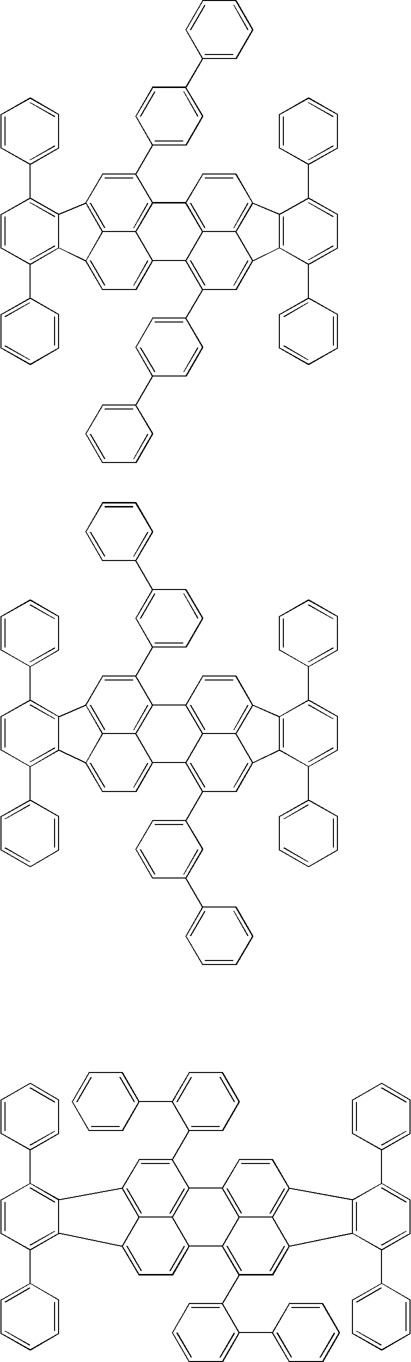

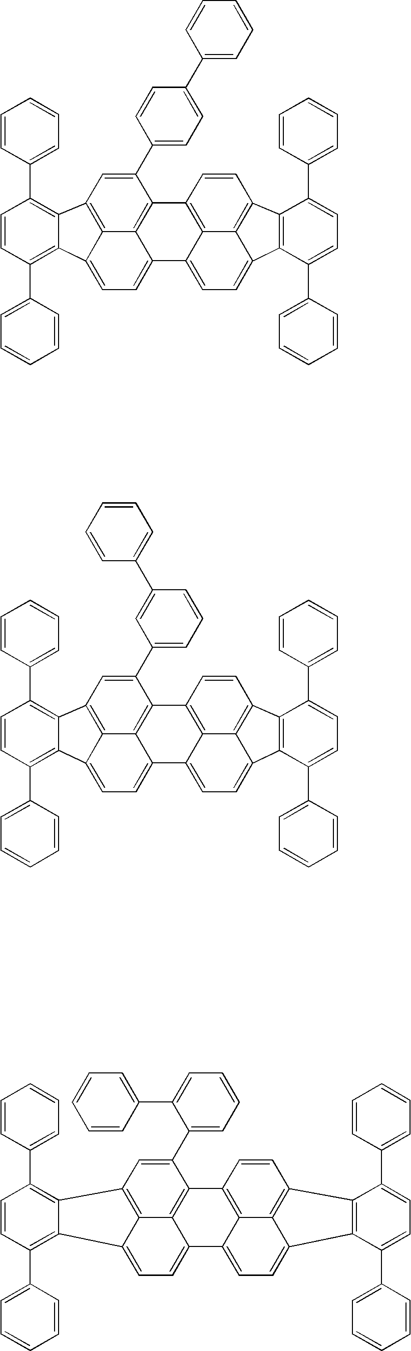

As examples of the condensed aromatic ring having 10 to 50 nucleus carbon atoms of the compound having a condensed aromatic ring having 10 to 50 nucleus carbon atoms (compound B), anthracene, phenanthrene, pyrene, chrysene, triphenylene, perylene, and the like can be given. Of these, anthracene and pyrene are preferable.

In the invention, anthracene derivatives of the following formula (3), unsymmetrical anthracene derivatives of the following formula (4), unsymmetrical pyrene derivatives of the following formula (5), unsymmetrical diphenylanthracene derivatives of the following formula (6), or bispyrene derivatives of the following formula (7) are preferable. 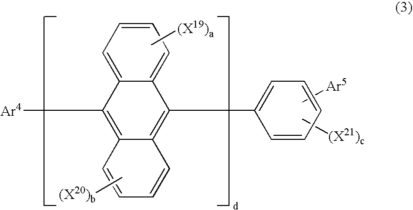
wherein X¹⁹ to X²¹ are each a hydrogen atom, substituted or unsubstituted aromatic group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arythio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; Ar⁴ and Ar⁵ are each independently a substituted or unsubstituted condensed aromatic group having 10 to 50 nucleus carbon atoms; and at least one of Ar⁴ and Ar⁵ is a 1-naphthyl group represented by the following formula (3a) or 2-naphthyl group represented by the following formula (3b), 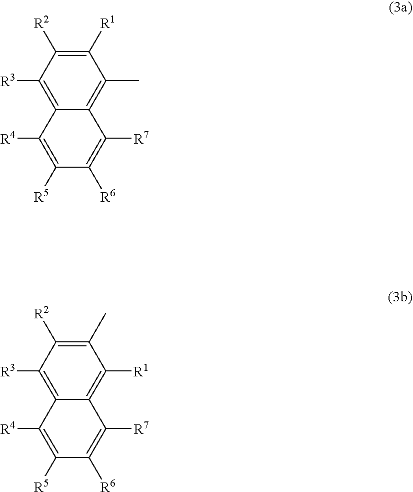
(wherein R¹ to R⁷ are each independently a hydrogen atom, or substituted or unsubstituted alkyl group having 1 to 50 carbon atoms; and at least one pair of adjacent groups of R¹ to R⁷ is bonded to each other to form a cyclic structure); a, b and c are each an integer of 0 to 4; d is an integer of 1 to 3; and the groups in [ ] of the formula may be the same or different when d is 2 or more.

Examples of the aromatic hydrocarbon groups of X¹⁹ to X²¹ include phenyl, 1-naphthyl, 2-naphthyl, 1-anthryl, 2-anthryl, 9-anthryl, 9-(10-phenyl)anthryl, 9-(10-naphtyl-1-yl)anthryl, 9-(10-naphtyl-2-yl)anthryl, 1-phenanthryl, 2-phenanthryl, 3-phenanthryl, 4-phenanthryl, 9-phenanthryl, 6-chrysenyl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, 3-methyl-2-naphthyl, 4-methyl-l-naphthyl and 4-methyl-l-anthryl groups.

Examples of the aromatic heterocyclic groups include 1-pyrrolyl, 2-pyrrolyl, 3-pyrrolyl, pyrazinyl, 2-pyridinyl, 1-imidazolyl, 2-imidazolyl, 1-pyrazoryl, 1-indolydinyl, 2-indolydinyl, 3-indolydinyl, 5-indolydinyl, 6-indolydinyl, 7-indolydinyl, 8-indolydinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, β-carboline-1-yl, β-carboline-3-yl, β-carboline-4-yl, β-carboline-5-yl, β-carboline-6-yl, β-carboline-7-yl, β-carboline-6-yl, β-carboline-9-yl, 1-phenanthrydinyl, 2-phenanthrydinyl, 3-phenanthrydinyl, 4-phenanthrydinyl, 6-phenanthrydinyl, 7-phenanthrydinyl, 8-phenanthrydinyl, 9-phenanthrydinyl, 10-phenanthrydinyl, 1-acrydinyl, 2-acrydinyl, 3-acrydinyl, 4-acrydinyl, 9-acrydinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl, 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methylpyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl 1-indolyl, 4-t-butyl 1-indolyl, 2-t-butyl 3-indolyl, and 4-t-butyl 3-indolyl groups.

Examples of the alkyl groups include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, and 1,2,3-trinitropropyl.

Examples of the cycloalkyl groups include cyclopropyl, cyclobutyl, cyclopentyl, cyclohexyl, 4-methylcyclohexyl, 1-adamanthyl, 2-adamanthyl, 1-norbornyl, and 2-norbornyl groups.

The substituted or unsubstituted alkoxy groups with 1 to 50 carbon atoms are groups represented by —OY. Examples of Y include the same groups as those of the alkyl groups.

Examples of the aralkyl groups include benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl, and 1-chloro-2-phenylisopropyl groups.

The aryloxy group is represented by —OY′. Examples of Y′ include the same groups as the above-mentioned examples for the aryl groups.

The arylthio group is represented by —SY′. Examples of Y′ include the same groups as the above-mentioned examples for the aromatic hydrocarbon and aromatic heterocyclic group.

The alkoxycarbonyl group is represented by —COOY. Examples of Y include the same groups as the above-mentioned examples for the alkyl groups.

The silyl group includes trimethylsilyl, triethylsilyl, t-butyldimethylsilyl, vinyldimethylsilyl, propyldimethylsilyl groups.

As examples of the condensed aromatic ring groups represented by Ar⁴ and Ar⁵, naphthalene, anthracene, phenanthrene, pyrene, chrysene, triphenylene, perylene, and the like can be given.

As examples of the alkyl groups represented by R¹ to R⁷, the alkyl groups given as examples for X¹⁹ to X²¹ can be given. As examples of the ring structure formed by R¹ to R⁷, cycloalkanes having 4 to 12 carbon atoms such as cyclobutane, cyclopentane, cyclohexane, adamantane, and norbornane can be given. 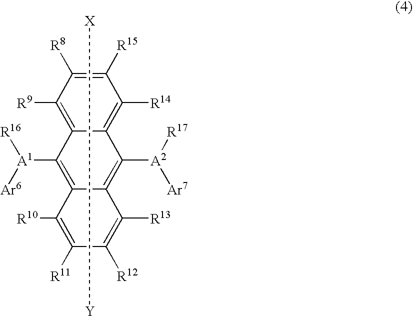
wherein A¹ and A² are independently a substituted or unsubstituted condensed aromatic hydrocarbon ring group having 10 to 20 nucleus carbon atoms; Ar⁶ and Ar⁷ are independently a hydrogen atom or substituted or unsubstituted aromatic hydrocarbon ring group with 6 to 50 nucleus carbon atoms; R⁸ to R¹⁵ are independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, a substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; R¹⁶ and R¹⁷ are each independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; and a plurality of Ar⁶, Ar⁷, R¹⁶ and R¹⁷ may bond to A¹ or A², or adjacent groups thereof may form a saturated or unsaturated cyclic structure; provided that groups do not symmetrically bond to 9 and 10 positions of the central anthracene with respect to X-Y axis.

As examples of the condensed aromatic rings represented by A¹ and A², the groups given as examples for Ar⁴ and Ar⁵ of the formula (5) and having 10 to 20 nucleus carbon atoms can be given.

As examples of the groups Ar⁶, Ar⁷, and R⁸ to R¹⁷ and the ring structure which may be formed by Ar⁶, Ar⁷, R¹⁶, and R¹⁷, cycloalkanes having 4 to 12 carbon atoms such as cyclobutane, cyclopentane, cyclohexane, adamantane, and norbornane, cycloalkenes having 4 to 12 carbon atoms such as cyclobutene, cyclopentene, cyclohexene, cycloheptene, and cyclooctene, cycloalkadienes having 6 to 12 carbon atoms such as cyclohexadiene, cycloheptadiene, and cyclooctadiene, aromatic rings having 6 to 50 carbon atoms such as benzene, naphthalene, phenanthrene, anthracene, pyrene, chrysene, and acenaphthylene, heterocyclic rings having 5 to 50 carbon atoms such as imidazole, pyrrole, furan, thiophene, and pyridine, and the like can be given. 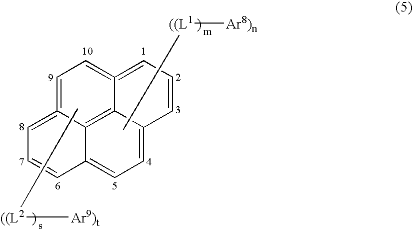
wherein Ar⁸ and Ar⁹ are each a substituted or unsubstituted aromatic group having 6 to 50 nucleus carbon atoms; L¹ and L² are each a substituted or unsubstituted phenylene group, substituted or unsubstituted naphthalenylene group, substituted or unsubstituted fluolenylene group, or substituted or unsubstituted dibenzosilolylene group; m is an integer of 0 to 2, n is an integer of 1 to 4, s is an integer of 0 to 2, and t is an integer of 0 to 4; L¹ or Ar⁸ bonds at any one position of 1 to 5 of the pyrene, and L² or Ar⁹ bonds at any one position of 6 to 10 of the pyrene; provided that when n+t is an even number, Ar⁸, Ar⁹, L¹ and L² satisfy the following (1) or (2):

(1) Ar⁸≠Ar⁹ and/or L¹≠L² where ≠ means that they are groups having different structures from each other.

(2) when Ar⁸═Ar⁹ and L¹=L²,

(2-1) m≠s and/or n≠t, or

(2-2) when m=s and n=t,
(2-2-1) L¹ and L², or the pyrene each bond to Ar⁸ and Ar⁹ at different positions, or
(2-2-2) when L¹ and L², or the pyrene each bond to Ar⁸ and Ar⁹ at the same positions, L¹ and L², or Ar⁸ and Ar⁹ are not in symmetric relation at substitution position in the pyrene.

Examples of the aromatic hydrocarbon and aromatic heterocyclic groups of Ar⁸ and Ar⁹ include the same groups as those for formula (5). 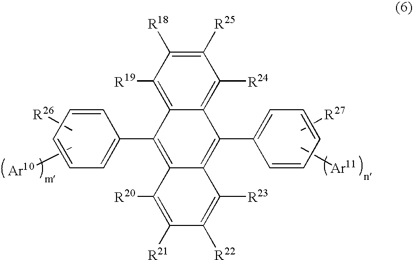
wherein Ar¹⁰ and Ar¹¹ are each independently a substituted or unsubstituted aromatic hydrocarbon ring group having 6 to 50 nucleus carbon atoms; and m′ and n′ are each an integer of 1 to 4; provided that in the case where m′=n′=1, and Ar¹⁰ and Ar¹¹ are symmetrically bonded to the benzene rings, Ar¹⁰ and Ar¹¹ are not the same, and in the case where m′ or n′ is an integer of 2 to 4, m′ is different from n′;

R¹⁸ to R²⁵ are each independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; and

R²⁶ and R²⁷ are each independently a hydrogen atom, substituted or unsubstituted aromatic hydrocarbon ring group having 6 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group.

As examples of the groups Ar¹⁰, Ar¹¹, and R¹⁸ to R²⁷, the groups given as examples for the formula (5) can be given.
(A³)ₑ-(X²²)_{f}—(Ar¹²)_{g}—(Y¹)ₕ—(B¹)ᵢ (7)
wherein X²² is independently a substituted or unsubstituted pyrene residue, A³ and B¹ are a hydrogen atom, a substituted or unsubstituted aromatic hydrocarbon group having 3 to 50 nucleus carbon atoms, a substituted or unsubstituted aromatic heterocyclic group having 1 to 50 nucleus carbon atoms, a substituted or unsubstituted alkyl group or alkylene group having 1 to 50 carbon atoms, or a substituted or unsubstituted alkenyl group or alkenylene group having 1 to 50 carbon atoms, Ar¹² is independently a substituted or unsubstituted aromatic hydrocarbon group having 3 to 50 nucleus carbon atoms or a substituted or unsubstituted aromatic heterocyclic group having 1 to 50 nucleus carbon atoms, and Y¹ is independently a substituted or unsubstituted aryl group. f is an integer of 1 to 3, e and i are independently integers of 0 to 4, h is an integer of 0 to 3, and g is an integer of 1 to 5.

As examples of the groups A³, B¹, and Ar¹², the groups given as examples for the formula (5) can be given.

As an example of the substituted or unsubstituted alkenyl group or alkenylene group having 1 to 50 carbon atoms, a styryl group can be given.

As examples of the condensed ring group or condensed heterocyclic group having 5 to 50 nucleus carbon atoms represented by Y¹, a naphthyl group, an anthryl group, a phenanthryl group, and a chrysenyl group can be given.

As examples of the substituent for each group of the formulas (3) to (7), a substituted or unsubstituted aromatic hydrocarbon group having 6 to 50 nucleus carbon atoms, a substituted or unsubstituted aromatic heterocyclic group having 5 to 50 nucleus atoms, a substituted or unsubstituted alkyl group having 1 to 50 carbon atoms, a substituted or unsubstituted cycloalkyl group having 3 to 50 nucleus carbon atoms, a substituted or unsubstituted alkoxy group having 1 to 50 carbon atoms, a substituted or unsubstituted aralkyl group having 6 to 50 carbon atoms, a substituted or unsubstituted aryloxy group having 5 to 50 nucleus atoms, a substituted or unsubstituted arylthio group having 5 to 50 nucleus atoms, a substituted or unsubstituted alkoxycarbonyl group having 1 to 50 carbon atoms, a substituted or unsubstituted silyl group, a carboxyl group, a halogen atom, a cyano group, a nitro group, a hydroxyl group, and the like can be given.

A compound of the following formula (8) may also be preferably used as the compound B.
X²³—(Y²)ⱼ (8)
wherein X²³ is a condensed aromatic ring group having two or more carbon rings, and Y² is independently a substituted or unsubstituted aryl group, a substituted or unsubstituted diarylamino group, a substituted or unsubstituted arylalkyl group, or a substituted or unsubstituted alkyl group. j is an integer of 1 to 6. When j is 2 or more, the Y²s may be the same or different.

In the formula (8), X²³ is preferably a group containing at least one skeleton selected from naphthacene, pyrene, benzoanthracene, pentacene, dibenzoanthracene, benzopyrene, benzofluorene, fluoranthene, benzofluoranthene, naphthylfluoranthene, dibenzofluorene, dibenzopyrene, dibenzofluoranthene and acenaphtylfluoranthene.

Y² is preferably an aryl group or a diarylamino group with 12 to 60 carbon atoms, more preferably an aryl group with 12 to 20 carbon atoms or a diarylamino group with 12 to 40 carbon atoms. n is preferably 2.

As the compound B, preferred are one or more compounds selected from naphthacene derivatives, anthracene derivatives, bisanthracene derivatives, pyrene derivatives, bispyrene derivatives, diaminoanthracene derivatives, naphthofluoranthene derivatives, diaminopyrene derivatives, diaminoperylene derivatives, dibenzidine derivatives aminoanthracene derivatives, aminopyrene derivatives and dibenzochrysene derivatives.

In the invention, it is preferable that the emitting layer of the organic thin film layer contain the compound A and the compound B. Since the compound A functions as a host material and the compound B functions as a dopant material, luminous efficiency is improved by using the compound A and the compound B for the emitting layer. In the organic EL device according to the invention, the electron transporting properties and the hole transporting properties of the emitting layer are improved by adjusting the ratio of the compound A and the compound B. This makes it possible to omit an intermediate layer such as a hole injecting layer, a hole transporting layer, and an electron injecting layer.

In the organic EL device according to the invention, the combination of the compound A and the compound B provides red light with high color purity without impairing the effect of emitting light with a long wavelength. A compound having a condensed aromatic ring having 10 to 50 nucleus carbon atoms and having an unsymmetrical structure such as the compound B, particularly a compound having the above-mentioned specific terminal substituent exhibits a high steric hindrance between compounds to prevent concentration quenching due to molecular association and achieves a further increase in lifetime, whereby red light with a high color purity is obtained while having a high luminous efficiency and an increased lifetime.

The color of red light from the organic EL device can be classified as orange (585 to 595 nm), red (maximum emission wavelength: 595 to 620 nm), and pure red (maximum emission wavelength: 620 to 700 nm) depending on the maximum emission wavelength of the emission spectrum.

In a red light emitting device which emits yellow-orange or red light, red light has a CIEx chromaticity coordinate value of the CIE chromaticity coordinates of 0.62 or more (preferably 0.62 or more and less than 0.73), and orange light has a CIEx chromaticity coordinate value of 0.54 or more and less than 0.62.

A compound represented by following formula (9) is preferably used as a material for forming an electron-transporting layer,
A⁴-B² (9)
wherein A⁴ is an aromatic hydrocarbon residue with 3 or more carboncircles and B² is a substituted or unsubstituted heterocyclic group.

The compound represented by formula (9) is preferably a heterocyclic compound containing in the molecule thereof at least one skeleton selected from anthracene, phenanthrene, naphthacene, pyrene, chrysene, benzoanthracene, pentacene, dibenzoanthracene, benzopyrene, fluorene, benzofluorene, fluoranthene, benzofluoranthene, naphthofluoranthene, dibenzofluorene, dibenzopyrene and dibenzofluoranthene; and is more preferably a nitrogen-containing heterocyclic compound.

The nitrogen-containing heterocyclic compound more preferably contains one or more nitrogen-containing heterocyclic compounds containing in the molecule thereof at least one skeleton selected from pyridine, pyrimidine, pyrazine, pyridazine, triazine, quinoline, quinoxaline, acridine, imidazopyridine, imidazopyrimidine and phenenthroline. As a nitrogen-containing heterocyclic compound, a benzoimidazole derivative represented by formula (10) or (11) can be given, 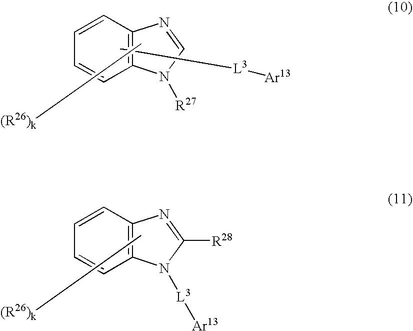
wherein R²⁶s are each independently a hydrogen atom, substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or substituted or unsubstituted alkoxy group having 1 to 20 carbon atoms; k is an integer of 0 to 4; R²⁷ is a substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or alkoxy group having 1 to 20 carbon atoms; R²⁸ is a hydrogen atom, substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or substituted or unsubstituted alkoxy group having 1 to 20 carbon atoms; L³ is a substituted or unsubstituted arylene group having 6 to 60 carbon atoms, substituted or unsubstituted pyridinylene group, substituted or unsubstituted quinolinylene group, or substituted or unsubstituted fluorenylene group; Ar¹³ is a substituted or unsubstituted arylene group having 6 to 60 carbon atoms, substituted or unsubstituted pyridinylene group, or substituted or unsubstituted quinolinylene group.

For the benzoimidazole derivatives represented by formulas (10) and (11), k is preferably 0, R²⁸ is preferably an aryl group, L³ is preferably an aryl group with 6 to 30 carbon atoms (more preferably 6 to 20 carbon atoms) and Ar¹³ is preferably an aryl group with 6 to 30 carbon atoms.

The formation of an electron-transporting layer containing such a compound preferably improves electron injecting properties.

In the organic EL device according to the invention, it suffices that at least one layer of the organic thin film layer contain the compound A and the compound B. A known configuration may be employed as the remaining configuration. The configuration of the organic EL device according to the invention is described below.

[Structure of Organic EL Device]

The typical examples of the structure of the organic EL device of the invention are shown below. The invention is not limited to these.

(1) Anode/hole-transporting layer/emitting layer/electron-transporting layer/cathode

(2) Anode/hole-injecting layer/hole-transporting layer/emitting layer/electron-transporting layer/cathode

(3) Anode/hole-transporting layer/emitting layer/electron-transporting layer/electron-injecting layer/cathode

(4) Anode/hole-injecting layer/hole-transporting layer/emitting layer/electron-transporting layer/electron-injecting layer/cathode

(5) Anode/insulative layer/hole-transporting layer/emitting layer/electron-transporting layer/cathode

(6) Anode/hole-transporting layer/emitting layer/electron-transporting layer/insulative layer/cathode

(7) Anode/insulative layer/hole-transporting layer/emitting layer/electron-transporting layer/insulative layer/cathode

(8) Anode/hole-injecting layer/hole-transporting layer/emitting layer/electron-transporting layer/insulative layer/cathode

(9) Anode/insulative layer/hole-injecting layer/hole-transporting layer/emitting layer/electron-transporting layer/electron-injecting layer/cathode

(10) Anode/insulative layer/hole-injecting layer/hole-transporting layer/emitting layer/electron-transporting layer/electron-injecting layer/insulative layer/cathode

Among these, the structures (1), (2), (3), (4), (7), (8) and (10) are generally preferably used.

An electron-transporting layer and electron-injecting layer may be separately formed as the above structures (3), (4), (9) and (10) in the invention. However, the structure wherein an electron-transporting layer only is formed as the other structures also has a greater lifetime than a conventional device.

[Transparent Substrate]

The organic EL device of the invention is formed on a transparent substrate. The transparent substrate is a substrate for supporting the organic EL device, and is preferably a flat and smooth substrate having a transmittance of 50% or more to light rays within visible ranges of 400 to 700 nm.

Specific examples thereof include glass plates and polymer plates. Examples of the glass plate include soda-lime glass, barium/strontium-containing glass, lead glass, aluminosilicate glass, borosilicate glass, barium borosilicate glass, and quartz. Examples of the polymer plate include polycarbonate, acrylic polymer, polyethylene terephthalate, polyethersulfide, and polysulfone.

For the type where light is not outcoupled through a substrate with a device formed thereon (for example, top-emission-type device), the substrate is not required to be transparent.

[Anode]

The anode of the organic thin film EL device plays a role for injecting holes into its hole-transporting layer or emitting layer. The anode effectively has a work function of 4.5 eV or more. Specific examples of the material of the anode used in the invention include indium tin oxide alloy (ITO), zinc tin oxide alloy (IZO), tin oxide (NESA), gold, silver, platinum, and copper.

Although these materials may be used individually, alloys thereof or materials wherein another element is added to the materials can be selected for use.

The anode can be formed by forming these electrode materials into a thin film by vapor deposition, sputtering or the like.

In the case where emission from the emitting layer is taken out through the anode, the transmittance of the anode to the emission is preferably more than 10%. The sheet resistance of the anode is preferably several hundreds Ω/□ or less. The film thickness of the anode, which varies depending upon the material thereof, is usually from 10 nm to 1 μm, preferably from 10 to 200 nm.

[Hole-Injecting/Transporting Layer]

The hole-injecting/transporting layer is a layer for helping the injection of holes into the emitting layer to transport the holes to a light emitting region. The hole mobility thereof is large and the ionization energy thereof is usually as small as 5.5 eV or less. Such a hole-injecting/transporting layer is preferably made of a material which can transport holes to the emitting layer at a lower electric field intensity. The hole mobility thereof is preferably at least 10⁻⁶ cm²/V·second when an electric field of, e.g., 10⁴ to 10⁶ V/cm is applied.

The material can be arbitrarily selected from materials which have been widely used as a hole-transporting material in photoconductive materials and known materials used in a hole-injecting layer of organic EL devices.

The hole-injecting/transporting layer can be formed by making a hole-injecting/transporting material into a thin film by a known method, such as vacuum deposition, spin coating, casting or LB technique. The film thickness of the hole-injecting/transporting layer is not particularly limited, and is usually from 5 nm to 5 μm.

[Emitting Layer]

The emitting layer of the organic EL device has the following functions in combination.

(i) Injecting function: function of allowing injection of holes from anode or hole injecting/transporting layer and injection of electrons from cathode or electron injecting/transporting layer upon application of electric field

(ii) Transporting function: function of moving injected carriers (electrons and holes) due to force of electric field

(iii) Emitting function: function of providing a site for recombination of electrons and holes to emit light

Note that electrons and holes may be injected into the emitting layer with different degrees, or the transportation capabilities indicated by the mobility of holes and electrons may differ. It is preferable that the emitting layer move either electrons or holes.

As the method of forming the emitting layer, a known method such as deposition, spin coating, or an LB method may be applied. It is preferable that the emitting layer be a molecular deposition film.

The term “molecular deposition film” refers to a thin film formed by depositing a vapor-phase material compound or a film formed by solidifying a solution-state or liquid-phase material compound. The molecular deposition film is distinguished from a thin film (molecular accumulation film) formed using the LB method by the difference in aggregation structure or higher order structure or the difference in function due to the difference in structure.

The emitting layer may also be formed by dissolving a binder such as a resin and a material compound in a solvent to obtain a solution, and forming a thin film of the solution by spin coating or the like, as disclosed in JP-A-57-51781.

The emitting layer mainly contains a host material and a dopant material. The doping concentration of the dopant material contained in the emitting layer is preferably 0.1 to 10 wt %, and more preferably 0.5 to 2 wt %. In the invention, it is preferable to use the compound B as the dopant material and the compound A as the host material as described above.

[Electron Injecting Layer/Electron Transporting Layer]

The electron injecting/transporting layer is a layer which assists injection of electrons into the emitting layer and transports electrons to the emitting region, and exhibits a high electron mobility. In the invention, it is preferable that the layer be formed of the above-mentioned compounds of the formulas (9) to (11).

An adhesion improving layer may be formed which functions as an electron injecting/transporting layer and is formed of a material which exhibits excellent adhesion to the cathode.

A preferred embodiment of the invention is a device containing a reducing dopant in an interfacial region between its electron transferring region or cathode and organic layer. The reducing dopant is defined as a substance which can reduce an electron transferring compound. Accordingly, various substances which have given reducing properties can be used. For example, at least one substance can be preferably used which is selected from the group consisting of alkali metals, alkaline earth metals, rare earth metals, alkali metal oxides, alkali metal halides, alkaline earth metal oxides, alkaline earth metal halides, rare earth metal oxides, rare earth metal halides, alkali metal organic complexes, alkaline earth metal organic complexes, and rare earth metal organic complexes.

More specific examples of the preferred reducing dopants include at least one alkali metal selected from the group consisting of Na (work function: 2.36 eV), K (work function: 2.28 eV), Rb (work function: 2.16 eV) and Cs (work function: 1.95 eV), and at least one alkaline earth metal selected from the group consisting of Ca (work function: 2.9 eV), Sr (work function: 2.0 to 2.5 eV), and Ba (work function: 2.52 eV). Metals having a work function of 2.9 eV or less are in particular preferred. Among these, a more preferable reducing dopant is at least one alkali metal selected from the group consisting of K, Rb and Cs. Even more preferable is Rb or Cs. Most preferable is Cs. These alkali metals are particularly high in reducing ability. Thus, the addition of a relatively small amount thereof to an electron injecting zone makes it possible to improve the luminance of the organic EL device and make the lifetime thereof long. As the reducing dopant having a work function of 2.9 eV or less, any combination of two or more out of these alkali metals is also preferred. Particularly preferred is any combination containing Cs, for example, combinations of Cs and Na, Cs and K, Cs and Rb, or Cs, Na and K. The combination containing Cs makes it possible to exhibit the reducing ability efficiently. The luminance of the organic EL device can be improved and the lifetime thereof can be made long by the addition thereof to its electron-injecting zone.

In the invention, an electron-injecting layer made of an insulator or a semiconductor may further be provided between a cathode and an organic layer. By providing the layer, current leakage can be effectively prevented to improve the injection of electrons. As the insulator, at least one metal compound selected from the group consisting of alkali metal calcogenides, alkaline earth metal calcogenides, halides of alkali metals and halides of alkaline earth metals can be preferably used. When the electron-injecting layer is formed of the alkali metal calcogenide or the like, the injection of electrons can be preferably further improved. Specifically preferable alkali metal calcogenides include Li₂O, LiO, Na₂S, Na₂Se and NaO and preferable alkaline earth metal calcogenides include CaO, BaO, SrO, BeO, BaS and CaSe. Preferable halides of alkali metals include LiF, NaF, KF, LiCl, KCl and NaCl. Preferable halides of alkaline earth metals include fluorides such as CaF₂, BaF₂, SrF₂, MgF₂ and BeF₂ and halides other than fluorides.

Examples of the semiconductor for forming an electron-injecting layer include oxides, nitrides or oxynitrides containing at least one element selected from Ba, Ca, Sr, Yb, Al, Ga, In, Li, Na, Cd, Mg, Si, Ta, Sb and Zn, and combinations of two or more thereof. The inorganic compound for forming an electron-injecting layer is preferably a microcrystalline or amorphous insulating thin film. When an electron-injecting layer is formed of the insulating thin film, a more uniform thin film can be formed to reduce pixel defects such as dark spots. Examples of such an inorganic compound include the above-mentioned alkali metal calcogenides, alkaline earth metal calcogenides, halides of alkali metals, and halides of alkaline earth metals.

[Cathode]

For the cathode, the following may be used: an electrode substance made of a metal, an alloy or an electroconductive compound, or a mixture thereof which has a small work function (4 eV or less). Specific examples of the electrode substance include sodium, sodium-potassium alloy, magnesium, lithium, magnesium/silver alloy, aluminum/aluminum oxide, aluminum/lithium alloy, indium, and rare earth metals.

This cathode can be formed by making the electrode substances into a thin film by vapor deposition, sputtering or some other method.

In the case where emission from the emitting layer is taken out through the cathode, it is preferred to make the transmittance of the cathode to the emission larger than 10%.

The sheet resistance of the cathode is preferably several hundreds Ω/□ or less, and the film thickness thereof is usually from 10 nm to 1 μm, preferably from 50 to 200 nm.

[Insulative Layer]

In the organic EL device, pixel defects based on leakage or a short circuit are easily generated since an electric field is applied to the super thin film. In order to prevent this, it is preferred to insert an insulator thin layer between the pair of electrodes.

Examples of the material used in the insulative layer include aluminum oxide, lithium fluoride, lithium oxide, cesium fluoride, cesium oxide, magnesium oxide, magnesium fluoride, calcium oxide, calcium fluoride, cesium fluoride, cesium carbonate, aluminum nitride, titanium oxide, silicon oxide, germanium oxide, silicon nitride, boron nitride, molybdenum oxide, ruthenium oxide, and vanadium oxide. A mixture or laminate thereof may be used.

[Example of Fabricating Organic EL Device]

The organic EL device can be fabricated by forming an anode, a hole-transporting layer, an emitting layer and an electron-transporting layer, optionally forming a hole-injecting layer and an electron-injecting layer if necessary, and further forming a cathode by use of the materials and methods exemplified above. The organic EL device can be fabricated in the order reverse to the above, i.e., the order from a cathode to an anode.

An example of the fabrication of the organic EL device will be described below which has a structure wherein the following are successively formed on a transparent substrate: anode/hole-transporting layer/emitting layer/electron-transporting layer/cathode.

First, a thin film made of an anode material is formed into a thickness of 1 μm or less, preferably 10 to 200 nm on an appropriate transparent substrate by vapor deposition, sputtering or some other method, thereby forming an anode.

Next, a hole-transporting layer is formed on this anode. As described above, the hole-transporting layer can be formed by vacuum deposition, spin coating, casting, LB technique, or some other method. Vacuum deposition is preferred since a homogenous film is easily obtained and pinholes are not easily generated. In the case where the hole-transporting layer is formed by vacuum deposition, conditions for the deposition vary depending upon the compound used, the desired crystal structure or recombining structure of the hole-transporting layer, and others. In general, the conditions are preferably selected from the following: deposition source temperature of 50 to 450° C., vacuum degree of 10⁻⁷ to 10⁻³ torr, vapor deposition rate of 0.01 to 50 nm/second, substrate temperature of −50 to 300° C., and film thickness of 5 nm to 5 μm.

Next, an emitting layer is disposed on the hole-transporting layer. The emitting layer can also be formed by using a desired organic luminescent material and making the material into a thin film by vacuum deposition, sputtering, spin coating, casting or some other method. Vacuum deposition is preferred since a homogenous film is easily obtained and pinholes are not easily generated. In the case where the emitting layer is formed by vacuum deposition, conditions for the deposition, which vary depending on the compound used, can be generally selected from conditions similar to those for the hole-transporting layer.

Next, an electron-transporting layer is formed on this emitting layer. Like the hole-transporting layer and the emitting layer, the layer is preferably formed by vacuum deposition because a homogenous film is required. Conditions for the deposition can be selected from conditions similar to those for the hole-transporting layer and the emitting layer.

Lastly, a cathode is stacked thereon to obtain an organic EL device.

The cathode is made of a metal, and vapor deposition or sputtering may be used. However, vacuum deposition is preferred in order to protect underlying organic layers from being damaged when the cathode film is formed.

For the organic EL device fabrication that has been described above, it is preferred that the formation from the anode to the cathode is continuously carried out, using only one vacuuming operation.

The method for forming each of the layers in the organic EL device of the invention is not particularly limited. A known forming method, such as vacuum deposition, molecular beam deposition, spin coating, dipping, casting, bar coating or roll coating can be used.

The film thickness of each of the organic layers in the organic EL device of the invention is not particularly limited. In general, defects such as pinholes are easily generated when the film thickness is too small. Conversely, a high applied voltage becomes necessary, leading to low efficiency, when the film thickness is too large. Usually, therefore, the film thickness is preferably in the range of several nanometers to one micrometer.

### EXAMPLES

### Example 1

A transparent electrode made of an indium tin oxide with a thickness of 120 nm was provided on a grass substrate measuring 25 mm by 75 mm by 0.7 mm. The grass substrate was subjected to ultrasonic cleaning with isopropyl alcohol for 5 minutes, and cleaned with ultraviolet ozone for 30 minutes. The resultant substrate was mounted in a vacuum deposition device.

N′,N″-bis[4-(diphenylamino)phenyl]-N′,N″-diphenylbiphenyl-4,4′-diamine was deposited to form a 60 nm thick film as an hole-injecting layer on the substrate. Thereafter N,N′-bis[4′-{N-(naphthyl-1-yl)-N-phenyl}aminobiphenyl-4-yl]-N-phenylamine was deposited to form a 10 nm thick film as a hole-transporting layer thereon. Next, the compound (A-1) of a naphthacene derivative shown below and the compound (B-1) of an indenoperylene derivative shown below were co-deposited such that the weight ratio of A-1 to B-1 was 40 to 0.4, to form a 40 nm thick film as an emitting layer.

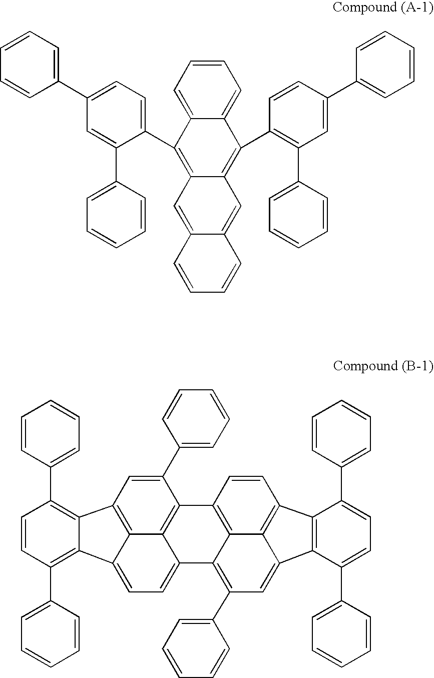

Next, the compound (C-1) shown below was deposited to form a 30 nm thick film as an electron-transporting layer.

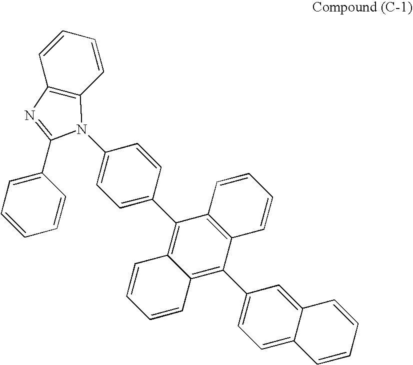

Next, lithium fluoride was deposited to form a 0.3 nm thick film, and then aluminum was deposited to form a 150 nm thick film. This aluminum/lithium fluoride functioned as a cathode. An organic EL device was thus fabricated.

For the device thus obtained, a conduction test was performed. Red emission with a driving voltage of 4.1 V and emission luminance of 1135 cd/m² was obtained at a current density of 10 MA/cm². The chromaticity coordinates were (0.66, 0.32) and the efficiency was 11.07 cd/A. A direct current continuous applying test was conducted at an initial luminance of 5000 cd/m², and a period of time until the luminance reached 80% of the initial luminance was 2010 hours.

### Example 2

An organic EL device was fabricated and evaluated in the same way as in Example 1 except that the compound (B-2) was used instead of the indenoperylene compound (B-1). The evaluation results are shown in Table 1.

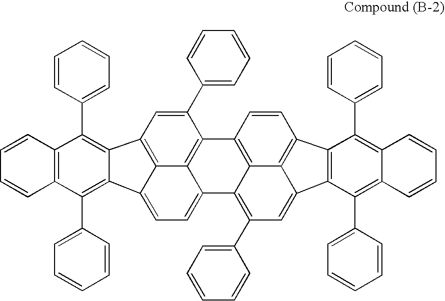

### Examples 3 to 6

Organic EL devices were fabricated and evaluated in the same way as in Example 1 except that the compounds (A-2) to (A-5) were used instead of the compound (A-1) The evaluation results are shown in Table 1.

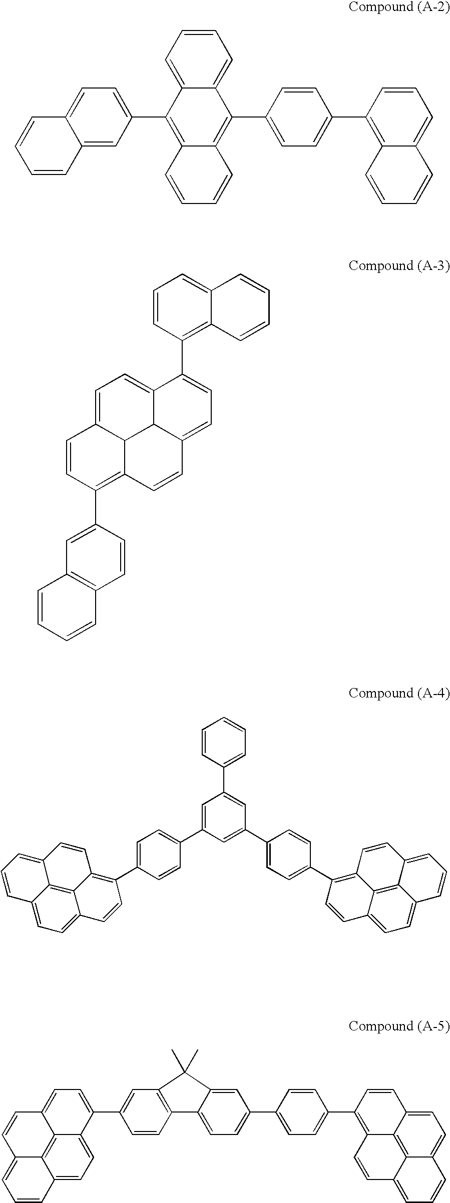

### Comparative Example 1

An organic EL device was fabricated and evaluated in the same way as in Example 1 except that the compound (b-1) was used instead of the compound (B-1) and Alq3 was used instead of the compound (C-1).

TABLE 1

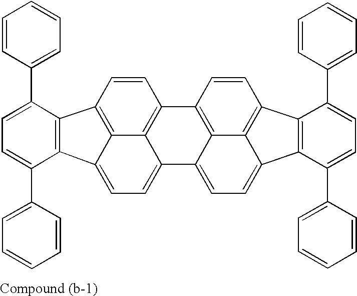

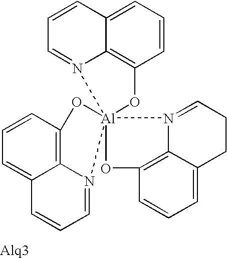

| | | | | | Lumin- | | |
|---|---|---|---|---|---|---|---|
| | | Dop- | Electron | | ous | | |
| | Host | ant | -trans- | Driving | eff- | Chrom- | 80% |
| | mat- | mat- | porting | voltage | iciency | aticity | lifetime |
| | terial | terial | materialk | (V) | (cd/A) | (x,y) | (h) |
| Exam- | A-1 | B-1 | C-1 | 4.1 | 11.07 | (0.66, | 2010 |
| ple 1 | | | | | | 0.32) | |
| Exam- | A-1 | B-2 | C-1 | 4.1 | 11.35 | (0.67, | 2100 |
| ple 2 | | | | | | 0.33) | |
| Exam- | A-2 | B-1 | C-1 | 4.7 | 9.16 | (0.65, | 1350 |
| ple 3 | | | | | | 0.33) | |
| Exam- | A-3 | B-1 | C-1 | 4.9 | 8.01 | (0.67, | 1170 |
| ple 4 | | | | | | 0.33) | |
| Exam- | A-4 | B-1 | C-1 | 4.8 | 8.35 | (0.67, | 1410 |
| ple 5 | | | | | | 0.33) | |
| Exam- | A-5 | B-1 | C-1 | 4.2 | 8.16 | (0.65, | 1510 |
| ple 6 | | | | | | 0.33) | |
| Comp. | A-1 | b-1 | Alq3 | 5.1 | 7.67 | (0.62, | 360 |
| Exam- | | | | | | 0.38) | |
| ple 1 | | | | | | | |

### INDUSTRIAL APPLICABILITY

The organic EL device of the invention can be used in the fields of various displays, back light, light source, indicators, signboards, Interiors and the like, and particularly to display device of color displays.

What is claimed is:

1. An organic electroluminescent device comprising:
a cathode,
an anode, and
an organic thin film layer provided between the cathode and the anode, the organic thin layer comprising one or plural layers including an emitting layer;
at least one layer of the organic thin film layer comprising an indenoperylene compound having at least one substituent on the central perylene ring, and a compound having a condensed aromatic ring with 10 to 50 nucleus carbon atoms.

2. The organic electroluminescent device according to claim 1 wherein the indenoperylene compound is a compound represented by the following formula (1) or (2): 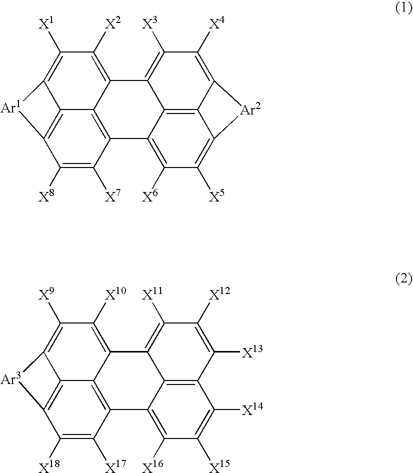
wherein Ar¹, Ar² and Ar³ are each independently a substituted or unsubstituted aromatic ring group, or aromatic heterocyclic group; X¹ to X¹⁸ are each independently a hydrogen atom, halogen atom, alkyl group, alkoxy group, alkylthio group, alkenyl group, alkenyloxy group, alkenylthio group, aromatic-ring-containing alkyl group, aromatic-ring-containing alkyloxy group, aromatic-ring-containing alkylthio group, aromatic ring group, aromatic heterocyclic group, aromatic ring oxy group, aromatic ring thio group, aromatic ring alkenyl group, alkenyl aromatic ring group, amino group, carbazolyl group, cyano group, hydroxyl group, —COOR^{1′} (R^{1′} is a hydrogen atom, alkyl group, alkenyl group, aromatic-ring-containing alkyl group, or aromatic ring group), —COR^{2′} (R^{2′} is a hydrogen atom, alkyl group, alkenyl group, aromatic-ring-containing alkyl group, aromatic ring group or amino group) or —OCOR^{3′} (R^{3′} is an alkyl group, alkenyl group, aromatic-ring-containing alkyl group or aromatic ring group); adjacent groups of X¹ to X¹⁸ may be bonded to each other to form a ring with a substituted carbon atom; and at least one of X¹ to X¹⁸ is not a hydrogen atom.

3. The organic electroluminescent device according to claim 2 wherein the indenoperylene compound is a dibenzo tetraphenyl perifuranthene derivative.

4. The organic electroluminescent device according to claim 1 wherein the compound having a condensed aromatic ring with 10 to 50 nucleus carbon atoms is an anthracene derivative of the following formula (3), unsymmetrical anthracene derivative of the following formula (4), unsymmetrical pyrene derivative of the following formula (5), unsymmetrical diphenylanthracene derivative of the following formula (6), or bispyrene derivative of the following formula (7): 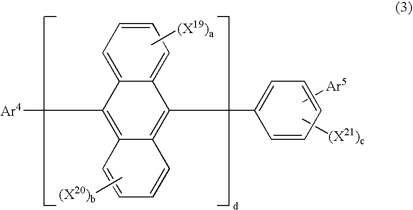
wherein X¹⁹ to X²¹ are each a hydrogen atom, substituted or unsubstituted aromatic group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arythio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; Ar⁴ and Ar⁵ are each independently a substituted or unsubstituted condensed aromatic group having 10 to 50 nucleus carbon atoms; and at least one of Ar⁴ and Ar⁵ is a 1-naphthyl group represented by the following formula (3a) or 2-naphthyl group represented by the following formula (3b), 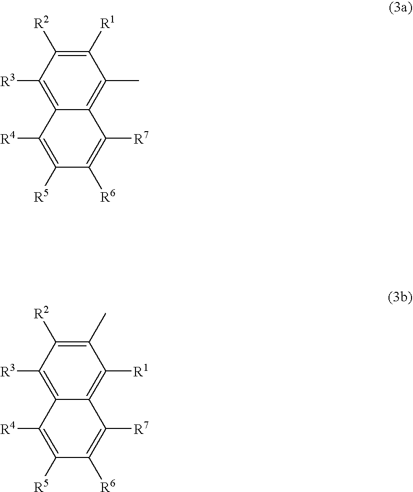
(wherein R¹ to R⁷ are each independently a hydrogen atom, or substituted or unsubstituted alkyl group having 1 to 50 carbon atoms; and at least one pair of adjacent groups of R¹ to R⁷ is bonded to each other to form a cyclic structure); a, b and c are each an integer of 0 to 4; d is an integer of 1 to 3; and the groups in [ ] of the formula may be the same or different when d is 2 or more: 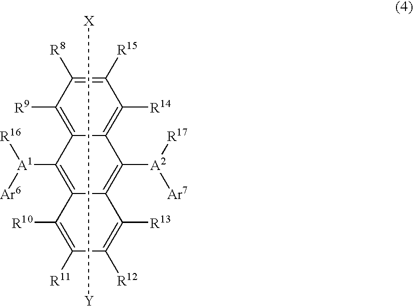
wherein A¹ and A² are independently a substituted or unsubstituted condensed aromatic hydrocarbon ring group having 10 to 20 nucleus carbon atoms; Ar⁶ and Ar⁷ are independently a hydrogen atom or substituted or unsubstituted aromatic hydrocarbon ring group with 6 to 50 nucleus carbon atoms; R⁸ to R¹⁵ are independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, a substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; R¹⁶ and R¹⁷ are each independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; and a plurality of Ar⁶, Ar⁷, R¹⁶ and R¹⁷ may bond to A¹ or A², or adjacent groups thereof may form a saturated or unsaturated cyclic structure; provided that groups do not symmetrically bond to 9 and 10 positions of the central anthracene with respect to X-Y axis: 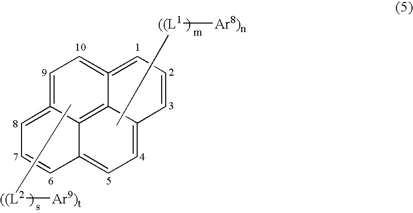
wherein Ar⁸ and Ar⁹ are each a substituted or unsubstituted aromatic group having 6 to 50 nucleus carbon atoms; L¹ and L² are each a substituted or unsubstituted phenylene group, substituted or unsubstituted naphthalenylene group, substituted or unsubstituted fluolenylene group, or substituted or unsubstituted dibenzosilolylene group; m is an integer of 0 to 2, n is an integer of 1 to 4, s is an integer of 0 to 2, and t is an integer of 0 to 4; L¹ or Ar⁸ bonds at any one position of 1 to 5 of the pyrene, and L² or Ar⁹ bonds at any one position of 6 to 10 of the pyrene; provided that when n+t is an even number, Ar⁸, Ar⁹, L¹ and L² satisfy the following (1) or (2):
(1) Ar⁸≠Ar⁹ and/or L¹≠L² where ≠ means that they are groups having different structures from each other.
(2) when Ar⁸═Ar⁹ and L¹=L²,
(2-1) m≠s and/or n≠t, or
(2-2) when m=s and n=t,
(2-2-1) L¹ and L², or the pyrene each bond to Ar⁸ and Ar⁹ at different positions, or
(2-2-2) when L¹ and L², or the pyrene each bond to Ar⁸ and Ar⁹ at the same positions, L¹ and L², or Ar⁸ and Ar⁹ are not in symmetric relation at substitution position in the pyrene: 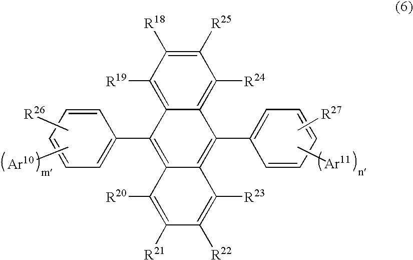
wherein Ar¹⁰ and Ar¹¹ are each independently a substituted or unsubstituted aromatic hydrocarbon ring group having 6 to 50 nucleus carbon atoms; and m′ and n′ are each an integer of 1 to 4; provided that in the case where m′=n′=1, and Ar¹⁰ and Ar¹¹ are symmetrically bonded to the benzene rings, Ar¹⁰ and Ar¹¹ are not the same, and in the case where m′ or n′ is an integer of 2 to 4, m′ is different from n′;
R¹⁸ to R²⁵ are each independently a hydrogen atom, substituted or unsubstituted aromatic hydrocarbon ring group having 6 to 50 nucleus carbon atoms, substituted or unsubstituted aromatic heterocyclic group having 5 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group; and
R²⁶ and R²⁷ are each independently a hydrogen atom, substituted or unsubstituted aromatic hydrocarbon ring group having 6 to 50 nucleus carbon atoms, substituted or unsubstituted alkyl group having 1 to 50 carbon atoms, substituted or unsubstituted cycloalkyl group having 3 to 50 carbon atoms, substituted or unsubstituted alkoxy group having 1 to 50 carbon atoms, substituted or unsubstituted aralkyl group having 6 to 50 carbon atoms, substituted or unsubstituted aryloxy group having 5 to 50 carbon atoms, substituted or unsubstituted arylthio group having 5 to 50 carbon atoms, substituted or unsubstituted alkoxycarbonyl group having 1 to 50 carbon atoms, substituted or unsubstituted silyl group, carboxyl group, halogen atom, cyano group, nitro group or hydroxyl group:
(A³)ₑ-(X²²)_{f}—(Ar¹²)_{g}—(Y¹)ₕ—(B¹)ᵢ (7)
wherein X²² is independently a substituted or unsubstituted pyrene residue, A³ and B¹ are a hydrogen atom, a substituted or unsubstituted aromatic hydrocarbon group having 3 to 50 nucleus carbon atoms, a substituted or unsubstituted aromatic heterocyclic group having 1 to 50 nucleus carbon atoms, a substituted or unsubstituted alkyl group or alkylene group having 1 to 50 carbon atoms, or a substituted or unsubstituted alkenyl group or alkenylene group having 1 to 50 carbon atoms, Ar¹² is independently a substituted or unsubstituted aromatic hydrocarbon group having 3 to 50 nucleus carbon atoms or a substituted or unsubstituted aromatic heterocyclic group having 1 to 50 nucleus carbon atoms, and Y¹ is independently a substituted or unsubstituted aryl group. f is an integer of 1 to 3, e and i are independently integers of 0 to 4, h is an integer of 0 to 3, and g is an integer of 1 to 5.

5. The organic electroluminescent device according to claim 1 wherein the compound having a condensed aromatic ring with 10 to 50 nucleus carbon atoms is a compound represented by the following formula (8):
X²³—(Y²)ⱼ (8)
wherein X²³ is a condensed aromatic ring group having two or more carbon rings, and Y² is independently a substituted or unsubstituted aryl group, a substituted or unsubstituted diarylamino group, a substituted or unsubstituted arylalkyl group, or a substituted or unsubstituted alkyl group. j is an integer of 1 to 6. When j is 2 or more, the Y²s may be the same or different.

6. The organic electroluminescent device according to claim 5 wherein X²³ of the formula (8) is derived from a compound containing a skeleton having 4 or more carbocycles selected from the group consisting of naphthacene, pyrene, benzoanthracene, pentacene, dibenzoanthracene, benzopyrene, benzofluorene, fluoranthene, benzofluoranthene, naphthylfluoranthene, dibenzofluorene, dibenzopyrene, dibenzofluoranthene and acenaphtylfluoranthene.

7. The organic electroluminescent device according to claim 5 wherein the compound represented by the formula (8) is one or more compounds selected from the group consisting of naphthacene derivatives, anthracene derivatives, benzoanthracene derivatives, dibenzoanthracene derivatives, pentacene derivatives, bisanthracene derivatives, pyrene derivatives, bispyrene derivatives, benzopyrene derivatives, dibenzopyrene derivatives, fluorene derivatives, benzofluorene derivatives, dibenzofluorene derivatives, fluoranthene derivatives, benzofluoranthene derivatives, dibenzofluoranthene derivatives, naphthylfluoranthene derivatives, acenaphthylfluoranthene derivatives, diaminoanthracene derivatives, naphthofluoranthene derivatives, diaminopyrene derivatives, diaminoperylene derivatives, dibenzidine derivatives, aminoanthracene derivatives, aminopyrene derivatives and dibenzochrysene derivatives.

8. The organic electroluminescent device according to claim 1 wherein the emitting layer comprises the indenoperylene compound and the compound having a condensed aromatic ring with 10 to 50 nucleus carbon atoms.

9. The organic electroluminescent device according to claim 1 wherein the organic thin film layer comprises an electron transporting layer, and the electron transporting layer comprises an aromatic hydrocarbon compound represented by the following formula (9)
A⁴-B² (9)
wherein A⁴ is an aromatic hydrocarbon group having two or more carbocycles, and B² is a substituted or unsubstituted heterocyclic group.

10. The organic electroluminescent device according to claim 9 wherein A⁴ of the formula (9) is a heterocyclic compound containing in the molecule thereof at least one skeleton selected from anthracene, phenanthrene, naphthacene, pyrene, chrysene, benzoanthracene, pentacene, dibenzoanthracene, benzopyrene, fluorene, benzofluorene, fluoranthene, benzofluoranthene, naphthofluoranthene, dibenzofluorene, dibenzopyrene and dibenzofluoranthene.

11. The organic electroluminescent device according to claim 9 wherein the compound represented by the formula (9) is a nitrogen-containing heterocyclic compound.

12. The organic electroluminescent device according to claim 11 wherein the nitrogen-containing heterocyclic compound is a compound represented by the following formula (10) or (11): 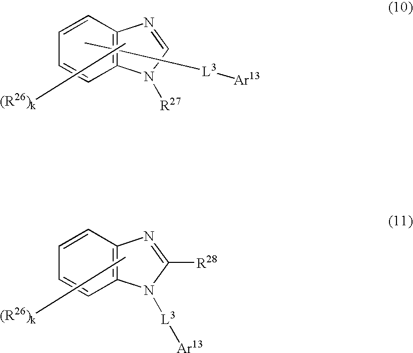
wherein R²⁶s are each independently a hydrogen atom, substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or substituted or unsubstituted alkoxy group having 1 to 20 carbon atoms; k is an integer of 0 to 4; R²⁷ is a substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or alkoxy group having 1 to 20 carbon atoms; R²⁸ is a hydrogen atom, substituted or unsubstituted aryl group having 6 to 60 carbon atoms, substituted or unsubstituted pyridyl group, substituted or unsubstituted quinolyl group, substituted or unsubstituted alkyl group having 1 to 20 carbon atoms, or substituted or unsubstituted alkoxy group having 1 to 20 carbon atoms; L³ is a substituted or unsubstituted arylene group having 6 to 60 carbon atoms, substituted or unsubstituted pyridinylene group, substituted or unsubstituted quinolinylene group, or substituted or unsubstituted fluorenylene group; Ar¹³ is a substituted or unsubstituted arylene group having 6 to 60 carbon atoms, substituted or unsubstituted pyridinylene group, or substituted or unsubstituted quinolinylene group.

13. The organic electroluminescent device according to claim 11 wherein the nitrogen-containing heterocyclic compound is a compound containing at least one skeleton selected from pyridine, pyrimidine, pyrazine, pyridazine, triazine, quinoline, quinoxaline, acridine, imidazopyridine, imidazopyrimidine and phenenthroline.

14. The organic electroluminescent device according to claim 1 whose emission color is orange to red.

15. The organic electroluminescent device according to claim 1 wherein the emitting layer contains a dopant material, and the concentration of the dopant material contained in the emitting layer is 0.1 to 10 wt %.

16. The organic electroluminescent device according to claim 15 wherein the concentration of the dopant material is 0.5 to 2 wt %.
